(19) United States
(12) Patent Application Publication
(10) Pub. No.: US 2009/0174266 A1
(43) Pub. Date: Jul. 9, 2009

(54) ELECTRICAL MACHINE WITH A DAMPING WINDING

(75) Inventors: Zeljko Jajtic, München (DE); Gerhard Matscheko, Starnberg (DE); Stefan Schiele, Stetten (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/295,085

(22) PCT Filed: Feb. 20, 2007
(86) PCT No.: PCT/EP07/51602

§ 371 Date: Sep. 29, 2008

(30) Foreign Application Priority Data
Mar. 29, 2006 (DE) 10 2006 014 613.1

(51) Int. Cl. H02K 41/02

(52) U.S. Cl. 310/12.21

(57) ABSTRACT

The aim of the invention is to reduce resonant overvoltages in electric motors. To achieve this, in an electric motor for an n-phase, symmetrical, electrical system comprising n working windings (Au, Av, Aw), which are assigned to the n phases (U, V, W) and are used to generate corresponding magnetic fluxes, a separate damper winding (Du, Dv, Dw) is allocated to each of the n working windings (Au, Av, Aw). The magnetic flux of the respective working winding flows through each damper winding. The n damper windings (Du, Dv, Dw) are connected in series and are short-circuited together. This permits the asymmetric parts of the system to be damped without affecting the working flux.

The present invention relates to an electrical machine for an n-phase, balanced electrical system having n main windings, which are associated with the n phases and by means of which magnetic fluxes can be produced in a corresponding manner.

By way of example, the expression electrical machines covers direct-drive electric motors, such as torque motors and linear motors. These must be precisely matched to the technical requirements for the drive, in particular with respect to the required speed and the required torque. In most direct drives, relatively low rotation speeds and high torques are therefore required from the motor, which in turn leads to high winding inductances L and winding capacitances C in the motors, since L is inversely proportional to the rotation speed, and C is proportional to the torque. In comparison to high-speed relatively small motors, this results in the motor winding having a considerably lower resonant frequency. This is proportional to 1/\sqrt{LC} and is normally in the range from about 20 kHz to 60 kHz. In the converter mode, the motor winding behaves like an RLC resonant circuit, which is caused to oscillate by a pulsed voltage on the motor terminals. This results in a voltage increase, which in some cases is considerable, within the motor winding. The overvoltages damage the motor insulation, and this often leads to insulation flashover and to motor failure with a ground fault.

In order to reduce the resonant voltage increases, an additional circuit with zener diode, for example, has until now been galvanically connected to the star point of the motor winding. This circuit short-circuits voltage spikes via a resistance to ground. To this end, the star point of the motor winding is in the form of a separate terminal. However, a circuit such as this is relatively complex and represents a potential hazard to the user on connection.

The object of the present invention is therefore to reduce resonant overvoltages in an electrical machine, without major complexity, and furthermore to avoid hazards for the user.

According to the invention, this object is achieved by an electrical machine for an n-phase, balanced electrical system having n main windings, which are associated with the n phases and by means of which magnetic fluxes can be produced in a corresponding manner, with each of the n main windings being associated with a separate damping winding through which the magnetic flux of the respective main winding flows, and with the n damping windings being connected in series and being short-circuited overall.

The damping windings according to the invention reduce resonant overvoltages in the machine windings or main windings. By way of example, this protects the motor insulation against flashover. Furthermore the damping winding, or the damping windings, requires or require no connections, which means that there is no additional circuit complexity for the user. In addition, the damping windings do not require external terminals on which high voltages can be present, thus making it possible to effectively reduce the potential hazard for the user.

In one specific embodiment, the damping windings can be short-circuited via a resistance. The damping effect can be optimized (R-L matching) by suitable choice of the resistance. A separate component may be used as the resistance, in which the power loss is deliberately dissipated (for example in order to provide a good cooling capability), or the damping winding is wound directly from a resistance wire, thus resulting in optimum resistance matching, without a separate resistance. The electrical machine is preferably designed for a three-phase system, with the main windings being connected in star. The invention can therefore advantageously be used for conventional three-phase systems.

Specifically, each of the n damping windings can be wound around the same pole tooth as the associated one of the n main windings. This ensures that the entire magnetic flux from the main winding also flows through the damping winding.

Furthermore, a plurality of pole teeth of the electrical machine can be connected to one another via a single yoke, a respective one of the n main windings can be arranged on the pole teeth, and each of the n damping windings may be located between the associated main winding and the yoke.

In particular, it is advantageous for the damping windings to be arranged in depressions in the yoke. This makes it possible to reduce the physical space for the damping windings in the active part of the electrical machine. The space required for the damping winding can also be reduced by means of a meandering winding shape. Furthermore, the damping windings may be manufactured from flat wire, from copper sheet or from copper strip. Damping windings can be produced at low cost from copper strip by stamping: stamp out the required contour layout of the damping winding from the copper strip, insert in slots in the electrical machine, and connect appropriately to form the damping winding. The flat form of the winding does not interfere with the slot geometry. In addition, this does not result in any additional complexity for the design of the slot insulation.

Furthermore, the electrical machine may have a cooling device in/on the damping windings. This cooling device is preferably also used to cool the main windings. The power loss which occurs in the damping windings can then be dissipated effectively in the same way as the power loss from the normal main windings.

The present invention will now be explained in more detail with reference to the attached drawings, in which:

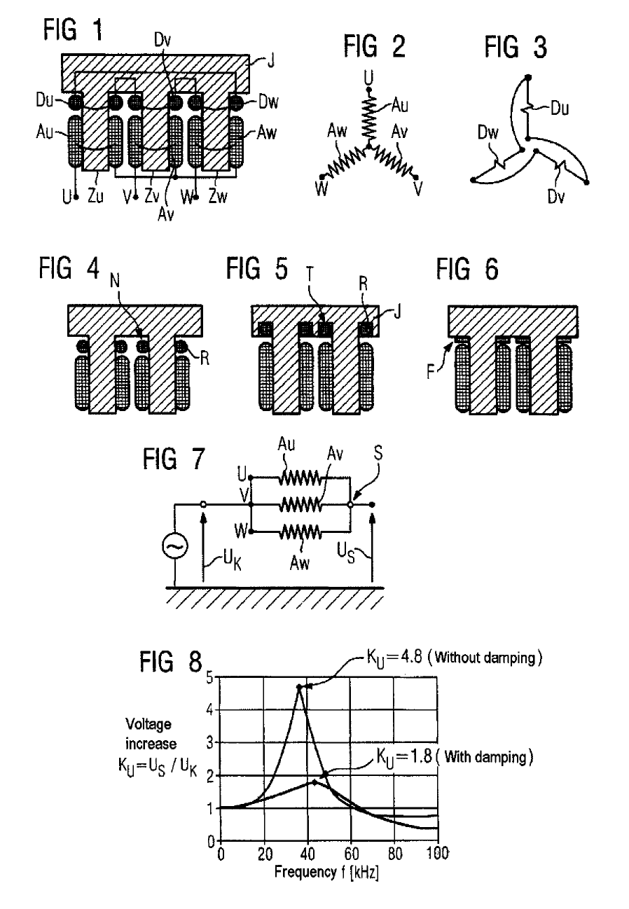

FIG. 1 shows a partial section view through the primary part of a linear motor according to the invention;

FIG. 2 shows the circuitry of the motor winding from FIG. 1;

FIG. 3 shows the circuitry of the damping winding from FIG. 1;

FIG. 4 shows an arrangement of the damping winding according to a first embodiment;

FIG. 5 shows an arrangement of the damping winding according to a second embodiment;

FIG. 6 shows the arrangement of the damping winding according to a third embodiment of the present invention;

FIG. 7 shows a circuit diagram for measurement of the voltage increase, and

FIG. 8 shows a measurement diagram of the voltage increase plotted against the frequency.

The exemplary embodiments which will be described in more detail in the following text represent preferred embodiments of the present invention.

A detail of a primary part according to the invention of a linear motor is illustrated schematically, in the form of a cross section, in FIG. 1. The illustration shows a section of the primary part with three pole teeth Zu, Zv and Zw for a three-phase system UVW. The pole teeth are connected to one another by means of a yoke. Main windings Au, Av and Aw are arranged on the pole teeth Zu, Zv and Zw. At one end, these main windings are connected to the corresponding phases U, V and W. At the other end, they are connected to one another in star. The basic circuitry of the main windings Au, Av and Aw is illustrated schematically in FIG. 2. The entire motor winding is thus connected in star.

A damping winding Du is located at the foot of the pole tooth Zu, that is to say between the main winding Au and the yoke J. A damping winding Dv is likewise located at the foot of the pole tooth Zv, between the main winding Av and the yoke J. Finally, a damping winding Dw is also located at the foot of the pole tooth Zw, between the main winding Aw and the yoke J. All the damping windings Du, Dv and Dw are connected in series, with the ends of this series circuit being short-circuited. This circuitry of the damping windings Du, Dv and Dw is illustrated in the form of a circuit diagram in FIG. 3. If required, the individual damping windings may be short-circuited via a resistance.

The damping windings Du, Dv and Dw make it possible to reduce the resonant overvoltages in the motor winding, that is to say the main windings Au, Av and Aw. The damping windings are formed from a small number of turns and are located in the laminated core of the motor, in the immediate vicinity of the main windings, and the respectively produced magnetic fluxes therefore flow through them. The damping winding arrangement with its damping windings Du, Dv and Dw has no electrical terminals. It is therefore a motor-internal short-circuited winding, for which no connections need be provided. In consequence, this does not result in any circuit complexity for the user, and there is no hazard presenting from external terminals with a high voltage.

The damping effect is based on the good electromagnetic coupling between each main winding and the associated damping winding via the laminated motor core. The damping windings Du, Dv and Dw are effective only when the UVW system is unbalanced. In this case, the unbalanced components are damped. In contrast, the useful flux remains undamped. This means that the three-phase, balanced electrical system which forms the torque is not adversely affected by the damping windings.

According to a first specific embodiment, which is illustrated in FIG. 4, a round wire R is used for the damping windings. The round wire is wound or laid in a slot window N.

In order to reduce the dimensions of the primary part or of the active part of the electrical machine, depressions T can be provided, as shown in FIG. 5, in the laminated core and, specifically in the yoke J, in which the round wire R of the damping winding is laid or wound. As can be seen from the graph in FIG. 5, this makes it possible to increase the height of the main windings in comparison to the exemplary embodiment shown in FIG. 4, or else to shorten the pole tooth length.

A further embodiment of a primary part according to the invention, which is very compact, is illustrated in FIG. 6. There, a flat wire F is used for the damping windings and can be merged with the laminated core, without any gap. Alternatively, a copper sheet can also be used for the flat wire F. This also makes it possible to make better use of the physical space available for the damping winding, so that the primary part can be made more compact.

The gain which can be achieved by the damping windings Du, Dv and Dw can be verified by means of the measurement circuit shown in FIG. 7. For this purpose, a measurement voltage U_{K} is applied to the motor terminals for the phases U, V and W. Since the main windings Au, Av and Aw are interconnected at a star point, this results in a measurement voltage or star-point voltage Us at this star point S.

The ratio K_{U}=U_{S}/U_{K} between the star-point voltage and the terminal voltage, which can also be referred to as the voltage increase, is illustrated in FIG. 8 for the damped situation and the undamped situation, plotted against the frequency. In the chosen example, the voltage increase in the undamped case is accordingly K_{U}=4.6, while the voltage increase in the damped case is only K_{U}=1.8. The damping therefore provides considerable protection for the motor insulation against resonant voltage increases.

1.-9. (canceled)

10. A linear motor having a converter for generating a pulsed voltage at motor terminals for an n-phase, balanced electrical system, comprising:
a primary part with n main windings for generating a magnetic flux, each winding associated with a corresponding one of the n phases, and
a separate damping winding associated with each of the n main windings in one-to-one correspondence, with the magnetic flux of a main winding flows extending through the associated separate damping winding,
wherein the n damping windings are connected in series and ends of the series connection of the n damping windings are connected to form a short-circuit, thereby damping resonant overvoltages caused by the pulsed voltage.

11. The linear motor of claim 10, wherein the series connection of the n damping windings is short-circuited with a serially connected resistance.

12. The linear motor of claim 10, wherein the n-phase system is a three-phase system and the main windings are connected in a star configuration.

13. The linear motor of claim 10, comprising a plurality of pole teeth, wherein each of the n main windings and the associated damping winding are wound around an identical pole tooth.

14. The linear motor of claim 13, further comprising a yoke connecting the plurality of pole teeth to one another, wherein the n main windings are arranged on the pole teeth in one-to-one correspondence, and wherein each of the n damping windings is located between the associated main winding and the yoke.

15. The linear motor of claim 14, wherein the damping windings are arranged in depressions formed in the yoke.

16. The linear motor of claim 10, wherein the damping windings are made of a flat wire.

17. The linear motor of claim 10, wherein the damping windings are made of copper sheet.
